(19) United States
(12) Patent Application Publication
(10) Pub. No.: US 2024/0372601 A1
(43) Pub. Date: Nov. 7, 2024

(54) METHODS AND APPARATUS OF MACHINE LEARNING BASED UE-INITIATED BEAM SWITCH

(71) Applicant: GUANGDONG OPPO MOBILE TELECOMMUNICATIONS CORP., LTD., Dongguan (CN)

(72) Inventor: Li GUO, Allen, TX (US)

(73) Assignee: GUANGDONG OPPO MOBILE TELECOMMUNICATIONS CORP., LTD., Dongguan (CN)

(21) Appl. No.: 18/777,332

(22) Filed: Jul. 18, 2024

Related U.S. Application Data
(63) Continuation of application No. PCT/IB2023/050411, filed on Jan. 18, 2023.
(60) Provisional application No. 63/266,891, filed on Jan. 18, 2022.

(51) Int. Cl. H04B 7/06; H04B 17/318; H04B 17/391

(52) U.S. Cl. CPC H04B 7/06952; H04B 7/0626; H04B 17/328; H04B 17/3913

(57) ABSTRACT

Methods and systems for beam switch measurement and reporting are provided. In some embodiments, the method includes (1) receiving, by the terminal device, configuration information of beams currently used by the terminal device; (2) receiving, by the terminal device, configuration information of candidate beams; (3) performing, by the terminal device, a first measurement on the beams currently used by the terminal device and a second measurement on the candidate beams; and (4) generating, by the terminal device, a beam switch decision for the beams currently used by the terminal device by applying a neural network on results of the first and second the measurements.

### CROSS-REFERENCE TO RELATED APPLICATION(S)

This application is a continuation of International Application No. PCT/IB2023/050411, filed on Jan. 18, 2023, which claims priority to U.S. Provisional Patent Application Ser. No. 63/266,891, filed on Jan. 18, 2022. The disclosures of the aforementioned applications are hereby incorporated by reference in their entireties.

### TECHNICAL FIELD

The present disclosure relates to link/beam recovery and switch. More specifically, systems and methods for enabling machine learning based link/beam failure detection/recovery are provided.

### BACKGROUND

New Radio (NR) and fifth generation (5G) communication systems support two different mechanisms for beam switch: (1) a base station (e.g., gNB) indicating beam switch and (2) a terminal device (e.g., UE) indicating beam switch. For gNB indicating beam switch, a base station provides a beam ID to a terminal device through a control signaling for example Media Access Control Control Element (MAC CE) or Downlink Control information (DCI). The terminal device then switches the current beam to receive or transmit some channel or signal according to the base station's indication.

UE indicating beam switch is implemented through a function of link recovery (i.e., beam failure recovery) in NR/5G system. However, conventional methods for detecting beam failure and determining new candidate beams in traditional link recovery function do not consider all the factors in complicated cellular communication environments. More particularly, the conventional methods of detecting beam failure simply assume that a beam failure only happens when a hypothetical Block Error Rate (BLER) is larger than a threshold consecutively for a given time duration. However, the calculated hypothetical BLER has a good amount of variation due to estimation noises and interference. Therefore, the conventional methods are not suitable for every communication environments. Therefore, improved systems and methods that can address the foregoing issues are desirable and beneficial.

### SUMMARY

The present disclosure is related to systems and methods for machine learning based, terminal-device-initiated link/beam failure detection/recovery. In some embodiments, a terminal device (e.g., UE) can be provided with configuration information of beams that are currently used for downlink transmission and/or uplink transmission by a base station (e.g., gNB). The base station can also provide configuration information of one or more candidate beams. The base station can provide configuration of a first neural network to the terminal device. The terminal device can be requested to measure the configured beams that are currently used as well as the configured candidate beams.

The terminal device can then be requested to input measurement results of the beams that are currently used and the candidate beams to the first neural network. The terminal device can obtain the output of the first neural network. The terminal device can report related information to the base station according to the output of the first neural network. After the terminal device reports to the base station, the base station can send an acknowledgement to the terminal device. Then the base station and the terminal device can switch to a new beam accordingly.

By the foregoing arrangements, the present systems and methods enables learning-based methods for beam switch calculation at the UE side. The accuracy of beam switch can be improved. Accordingly, overall performance of multi-beam operation in NR systems (e.g., in frequency range 2, FR2) is increased.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### BRIEF DESCRIPTION OF DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure.

FIG. 2 is a schematic block diagram of a terminal device in accordance with one or more implementations of the present disclosure.

FIG. 3 is a flowchart of a method in accordance with one or more implementations of the present disclosure.

FIG. 4 is a flowchart of a method in accordance with one or more implementations of the present disclosure.

### DESCRIPTION OF EMBODIMENTS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

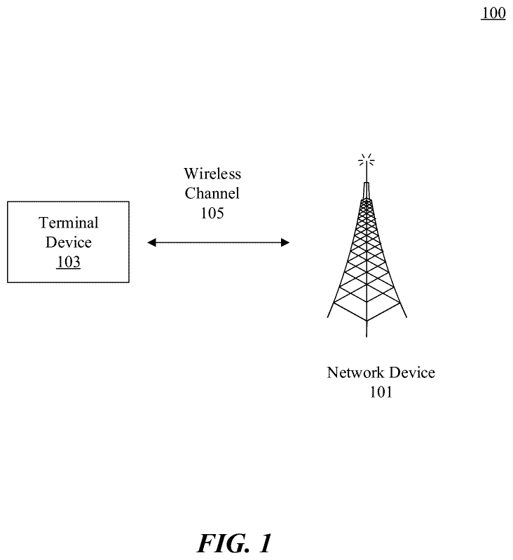

FIG. 1 is a schematic diagram of a wireless communication system 100 in accordance with one or more implementations of the present disclosure. The wireless communication system 100 can implement the methods discussed herein for beam failure detection and beam/link recovery. As shown in FIG. 1, the wireless communications system 100 includes a network device (or base station/cell) 101.

Examples of the network device 101 include a base transceiver station (BTS), a NodeB (NB), an evolved Node B (eNB or eNodeB), a Next Generation NodeB (gNB or gNode B), a Wireless Fidelity (Wi-Fi) access point (AP), etc. In some embodiments, the network device 101 can include a relay station, an access point, an in-vehicle device, a wearable device, and the like. The network device 101 can include wireless connection devices for communication networks such as: a Global System for Mobile Communications (GSM) network, a Code Division Multiple Access (CDMA) network, a Wideband CDMA (WCDMA) network, an LTE network, a cloud radio access network (CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (PLMN), or the like. A 5G system or network can be referred to as an NR system or network.

In FIG. 1, the wireless communications system 100 also includes a terminal device 103. The terminal device 103 can be an end-user device configured to facilitate wireless communication. The terminal device 103 can be configured to wirelessly connect to the network device 101 (via, e.g., via a wireless channel 105) according to one or more corresponding communication protocols/standards.

The terminal device 103 may be mobile or fixed. The terminal device 103 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 103 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 1 illustrates only one network device 101 and one terminal device 103 in the wireless communications system 100. However, in some instances, the wireless communications system 100 can include additional network device 101 and/or terminal device 103.

The terminal device 103 can be provided with configuration information of beams that are currently used for downlink transmission and/or uplink transmission by the network device 101. The network device 101 can also provide configuration information of one or more candidate beams. The network device 101 can provide configuration of a first neural network to the terminal device 103. The terminal device 103 can be requested to measure the configured beams that are currently used as well as the configured candidate beams. The terminal device 103 can then be requested to input measurement results of the beams that are currently used and the candidate beams to the first neural network. The terminal device 103 can obtain the output of the first neural network. The terminal device 103 can report related information to the base station according to the output of the first neural network. After the terminal device reports to the network device 101, the network device 101 can send an acknowledgement to the base station. Then the network device 101 and the terminal device 103 can switch to a new beam accordingly.

In some implementations, for the beams that are currently used, the terminal device 103 can measure one or more of the following measurement metrics: (1) Reference Signal Received Power (RSRP) measurement; (2) Reference Signal Received Quality (RSRQ) measurement; (3) Signal to Interference Noise Ratio (SINR) measurement; (4) Received Signal Strength Indication (RSSI) measurement; (5) hypothetical BLER measurement, etc.

In some implementations, for the candidate beams, the terminal device 103 can measure one or more of the following measurement metrics: (1) RSRP measurement; (2) RSRQ measurement; (3) SINR measurement; (4) RSSI measurement; (5) hypothetical BLER measurement, etc.

In some embodiments, the output of the first neural network can be one or more of the followings: (1) the beams that are used currently are good/suitable; (2) there is no need to switch beam; (2) the beams that are used currently has bad quality; (3) there is a need to switch beam; (4) there is a need to switch beam and a first beam is good candidate; (5) switch the current beams to a first beam, etc.

In some implementations, the terminal device 103 can be configured with a machine-learning based, UE-initiated beam switch function. The network device 101 can provide configuration information of a first set of Channel State Information Reference signal (CSI-RS) resources (which can contain one or more CSI-RS resources). The CSI-RS resources in the first set can be measured by the terminal device 103 to monitor a beam link quality of the current communication link. In other words, the CSI-RS resources in the first set can be used by the terminal device 103 to monitor the quality of beams that are currently used. The network device 101 can provide configuration information of a second set of CSI-RS resources and/or SSBs (Synchronization Signal/Physical Broadcast Channel Block), which can contain one or more CSI-RS resources and/or SSBs. The RS in the second set can be measured by the terminal device 103 so as to identify candidate beam(s). The terminal device 103 can also be provided with configuration information of a first neural network that is used to calculate a decision for beam switch.

In some embodiments, the terminal device 103 can be requested to measure one or more of the following metrics on the CSI-RS resources in the first set: (1) L1-RSRP measurement of CSI-RS resource; (2) L1-RSRQ measurement of CSI-RS resource; (3) L1-SINR measurement of CSI-RS resource, etc.

The terminal device 103 can be requested to measure one or more of the following metrics on the CSI-RS resources and/or SSBs in the second set: (1) L1-RSRP measurement of CSI-RS resource or SSB; (2) L1-RSRQ measurement of CSI-RS resource or SSB; (3) L1-SINR measurement of CSI-RS resource or SSB; (4) hypothetical BLER measurement of CSI-RS resource or SSB, etc.

The terminal device 103 can be requested to input the measurement results of CSI-RS resources in the first set and the measurement results of CSI-RS resources and/or SSBs in the second set to the first neural network. In such implementations, an output of the first neural network can be: (1) no beam switching is needed; (2) switching the current beam to a CSI-RS resource or SSB that is contained in the second set; (3) the beam of CSI-RS resources contained in the first set has a bad quality, etc.

According to the output of the first neural network, the terminal device 103 can report corresponding information to the network device 101. In some examples, the terminal device 103 can use Random Access Procedure (RACH) to report such information to the network device 101. In one example, the terminal device 103 can use MAC CE to report such information to the network device 101. In another example, the terminal device 103 can use Physical Uplink Control Channel (PUCCH) to report such information to the network device 101.

After receiving the reporting from the terminal device 103, the network device 101 can be requested to send a acknowledge to the terminal device 103. If the terminal device 103 reports CSI-RS resource ID or SSB ID that is contained in the second set according to the output of the first neural network, the network device 101 and the terminal device 103 switch the current beam for downlink transmission and/or uplink transmission to the beam corresponding to the reported CSI-RS resource or SSB by some predefined timing. In some embodiments, the predefined timing can include (1) after the base station sending an acknowledgement to the terminal device; (2) timing preset by a system operator; (3) timing determined based on the result of the beam measurement (e.g., if a quality different is greater than a threshold, perform the switch immediately or within a short period of time).

In some embodiments, the terminal device 103 can perform a function of link recovery that includes following steps: (1) beam failure detection; (2) identifying a candidate new beam reference signal (RS); (3) sending a beam failure recovery request to the base station; (4) resetting the transmission (Tx) beams of some downlink channel(s) and uplink channel(s).

In the “beam failure detection” step, the terminal device 103 is provided with a set of reference signals (for example, CSI-RS resources) for beam failure detection. In some embodiments, a “beam failure” is defined when the terminal device meets consecutive “N” beam failure instances. In some embodiments, when a beam failure is identified, the terminal device 103 can find a candidate new beam RS that is good for future communication between the network device 101 and the terminal device 103.

In some embodiments, when the beam failure is identified, the terminal device 103 can send a beam failure recovery request message to the base station. In the link recovery function for a Primary Cell (PCell), the terminal device 103 can send the beam failure recovery request message through a contention-free Random Access Channel (RACH). The terminal device 103 can be provided with an association between a candidate new beam RS and a RACH preamble. When the network device 101 receives one RACH preamble that is configured for beam failure recovery function, the network device 101 can obtain the following information: (1) the terminal device meets “beam failure” as defined; and (2) the RS associated with the received RACH preamble is candidate new beam RS selected by the terminal device.

In the link recovery function for a Secondary Cell (SCell), the terminal device can send a beam failure recovery request message through an MAC CE signaling. In the MAC CE message, the terminal device reports an index of the carrier component (CC) where the beam failure happens and the ID of the new candidate beam RS selected by the terminal device. When the base station receives the beam failure recovery request message from the terminal device, the base station can start the procedure to recovery transmission (Tx) beams on Physical Downlink Control Channel (PDCCH) and Tx beam on Physical Uplink Control Channel (PUCCH).

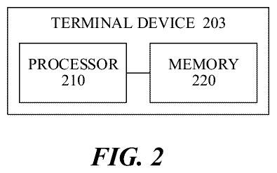

FIG. 2 is a schematic block diagram of a terminal device 203 (e.g., which can implement the methods discussed herein) in accordance with one or more implementations of the present disclosure. As shown, the terminal device 203 includes a processing unit 210 (e.g., a DSP, a CPU, a GPU, etc.) and a memory 220. The processing unit 210 can be configured to implement instructions that correspond to the methods discussed herein and/or other aspects of the implementations described above. It should be understood that the processor 210 in the implementations of this technology may be an integrated circuit chip and has a signal processing capability. During implementation, the steps in the foregoing method may be implemented by using an integrated logic circuit of hardware in the processor 210 or an instruction in the form of software. The processor 210 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 210 may be a microprocessor, or the processor 210 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 220, and the processor 210 reads information in the memory 220 and completes the steps in the foregoing methods in combination with the hardware thereof.

It may be understood that the memory 220 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

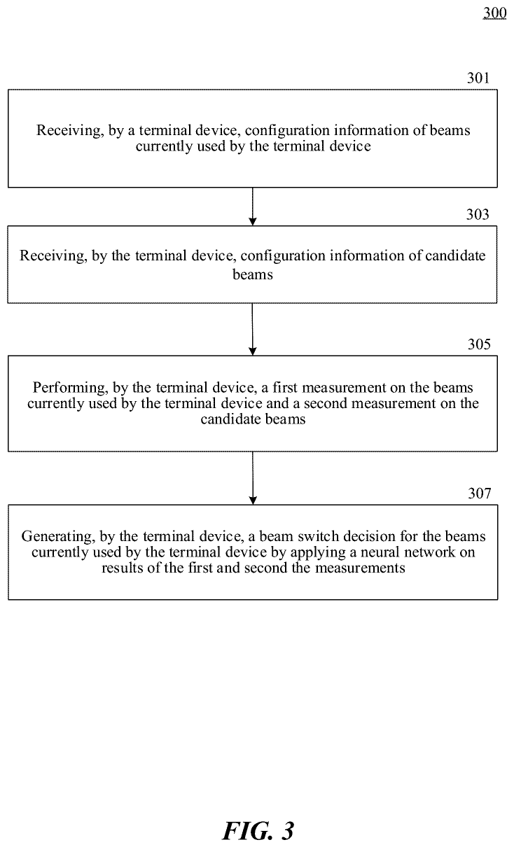

FIG. 3 is a flowchart of a method 300 in accordance with one or more implementations of the present disclosure. The method 300 can be implemented by a system (such as the wireless communications system 100). For example, the method 300 may also be implemented by the terminal device 103.

The method 300 includes, at block 301, receiving, by a terminal device, configuration information of beams currently used by the terminal device. At block 303, the method 300 continues by receiving, by the terminal device, configuration information of candidate beams. In some embodiments, the configuration information can be calculated by the terminal device.

At block 305, the method 300 continues by performing, by the terminal device, a first measurement on the beams currently used by the terminal device and a second measurement on the candidate beams. At block 307, the method 300 continues by generating, by the terminal device, a beam switch decision for the beams currently used by the terminal device by applying a neural network on results of the first and second the measurements.

In some embodiments, the method 300 can include receiving, by the terminal device, configuration information of the neural network for the beam switch decision. In some embodiments, the method 300 can include performing, by the terminal device, the beam switch decision by switching from at least one of the beams currently used by the terminal device to at least one of the candidate beams.

In some embodiments, the method 300 can include transmitting, by the terminal device, information corresponding to the beam switch decision to a base station, wherein the information corresponding to the beam switch decision includes identification of at least one RS resource in the second set. In some embodiments, the method 300 can include receiving, by the terminal device, an acknowledgement from the base station.

In some embodiments, the first measurement includes a Reference Signal Received Power (RSRP) measurement, a Reference Signal Received Quality (RSRQ) measurement, a Signal to Interference Noise Ratio (SINR) measurement, a Received Signal Strength Indication (RSSI) measurement, a hypothetical BLER measurement, etc.

In some embodiments, the second measurement includes an RSRP measurement, an RSRQ measurement, an SINR measurement, an RSSI measurement, a hypothetical BLER measurement, etc.

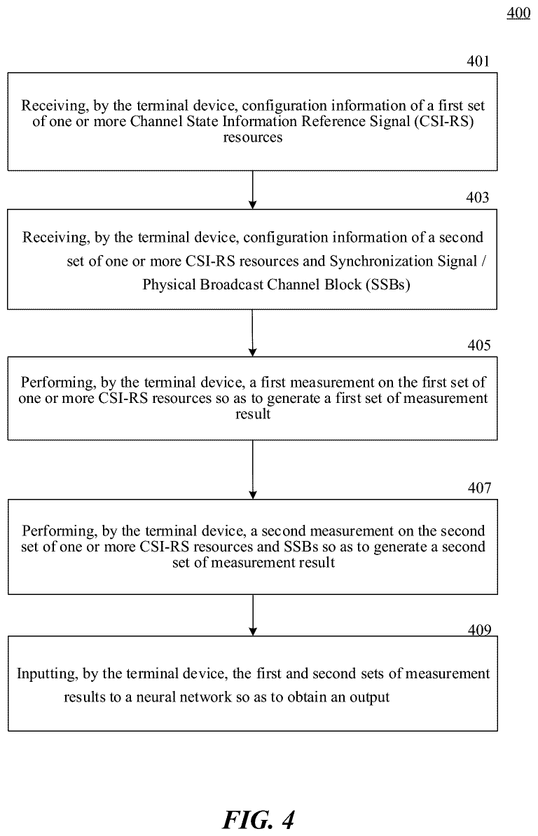

FIG. 4 is a flowchart of a method 400 in accordance with one or more implementations of the present disclosure. The method 400 can be implemented by a system (such as the wireless communications system 100). For example, the method 400 may also be implemented by the terminal device 103.

The method 400 includes, at block 401, receiving, by the terminal device, configuration information of a first set of one or more Channel State Information Reference Signal (CSI-RS) resources. At block 403, the method 400 continues by receiving, by the terminal device, configuration information of a second set of one or more CSI-RS resources and Synchronization Signal/Physical Broadcast Channel Block (SSBs).

At block 405, the method 400 continues by performing, by the terminal device, a first measurement on the first set of one or more CSI-RS resources so as to generate a first set of measurement result. At block 407, the method 400 continues by Performing, by the terminal device, a second measurement on the second set of one or more CSI-RS resources and SSBs so as to generate a second set of measurement result. At block 409, the method 400 continues by Inputting, by the terminal device, the first and second sets of measurement results to a neural network so as to obtain an output.

In some embodiments, the method 400 can include transmitting, by the terminal device, information corresponding to the output to a base station, wherein the information corresponding to the output includes identification of at least one RS resource in the second set. In some embodiments, the method 400 can include receiving, by the terminal device, an acknowledgement from the base station.

In some embodiments, the measurement on the “N” CSI-RS resources includes at least one of the following: an L1-RSRP measurement, an L1-RSRQ measurement, an L1-SINR measurement, a hypothetical BLER measurement, and corresponding Tx beams for the “N” CSI-RS resources.

In some embodiments, the first measurement includes at least one of the following: an RSRP measurement, an RSRQ measurement, an SINR measurement, an RSSI measurement, and a hypothetical BLER measurement.

In some embodiments, the second measurement includes at least one of the following: an RSRP measurement, an RSRQ measurement, an SINR measurement, an RSSI measurement, and a hypothetical BLER measurement.

### Additional Considerations

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the disclosure is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the disclosure are presented below in certain claim forms, the applicant contemplates the various aspects of the disclosure in any number of claim forms. Accordingly, the applicant reserves the right to pursue additional claims after filing this application to pursue such additional claim forms, in either this application or in a continuing application.

1. A method, comprising:
receiving, by the terminal device, configuration information of beams currently used by the terminal device;
receiving, by the terminal device, configuration information of candidate beams;
performing, by the terminal device, a first measurement on the beams currently used by the terminal device and a second measurement on the candidate beams; and
generating, by the terminal device, a beam switch decision for the beams currently used by the terminal device by applying a neural network on results of the first and second the measurements.

2. The method of claim 1, further comprising:
receiving, by the terminal device, configuration information of the neural network for the beam switch decision.

3. The method of claim 1, further comprising:
performing, by the terminal device, the beam switch decision by switching from at least one of the beams currently used by the terminal device to at least one of the candidate beams.

4. The method of claim 1, further comprising:
transmitting, by the terminal device, information corresponding to the beam switch decision to a base station, wherein the information corresponding to the beam switch decision includes identification of at least one RS resource in a set of one or more Channel State Information Reference Signal (CSI-RS) resources and Synchronization Signal/Physical Broadcast Channel Block (SSBs).

5. The method of claim 4, further comprising:
receiving, by the terminal device, an acknowledgement from the base station.

6. The method of claim 1, wherein the first measurement includes a Reference Signal Received Power (RSRP) measurement.

7. The method of claim 1, wherein the first measurement includes a Reference Signal Received Quality (RSRQ) measurement.

8. The method of claim 1, wherein the first measurement includes a Signal to Interference Noise Ratio (SINR) measurement.

9. The method of claim 1, wherein the first measurement includes a Received Signal Strength Indication (RSSI) measurement.

10. The method of claim 1, wherein the first measurement includes a hypothetical Block Error Rate (BLER) measurement.

11. The method of claim 1, wherein the second measurement includes an RSRP measurement.

12. The method of claim 1, wherein the second measurement includes an RSRQ measurement.

13. The method of claim 1, wherein the second measurement includes an SINR measurement.

14. The method of claim 1, wherein the second measurement includes an RSSI measurement.

15. The method of claim 1, wherein the second measurement includes a hypothetical BLER measurement.

16. A method, comprising:
receiving, by the terminal device, configuration information of a first set of one or more Channel State Information Reference Signal (CSI-RS) resources;
receiving, by the terminal device, configuration information of a second set of one or more CSI-RS resources and Synchronization Signal/Physical Broadcast Channel Block (SSBs);
performing, by the terminal device, a first measurement on the first set of one or more CSI-RS resources so as to generate a first set of measurement result;
performing, by the terminal device, a second measurement on the second set of one or more CSI-RS resources and SSBs so as to generate a second set of measurement result; and
inputting, by the terminal device, the first and second sets of measurement results to a neural network so as to obtain an output.

17. The method of claim 16, further comprising:
transmitting, by the terminal device, information corresponding to the output to a base station, wherein the information corresponding to the output includes identification of at least one RS resource in the second set; and
receiving, by the terminal device, an acknowledgement from the base station.

18. The method of claim 16, wherein the first measurement includes at least one of the following: an RSRP measurement, an RSRQ measurement, an SINR measurement, an RSSI measurement, and a hypothetical BLER measurement.

19. The method of claim 16, wherein the second measurement includes at least one of the following: an RSRP measurement, an RSRQ measurement, an SINR measurement, an RSSI measurement, and a hypothetical BLER measurement.

20. A system comprising:
a processor; and
a memory configured to store instructions, when executed by the processor, to:
receive, by the terminal device, configuration information of beams currently used by the terminal device;
receive, by the terminal device, configuration information of candidate beams;
perform, by the terminal device, a first measurement on the beams currently used by the terminal device and a second measurement on the candidate beams; and
generate, by the terminal device, a beam switch decision for the beams currently used by the terminal device by applying a neural network on results of the first and second the measurements.
